(19) United States
(12) Patent Application Publication
(10) Pub. No.: US 2022/0288975 A1
(43) Pub. Date: Sep. 15, 2022

(54) PNEUMATIC TIRE

(71) Applicant: Sumitomo Rubber Industries, Ltd., Kobe-shi (JP)

(72) Inventors: Takuya SATO, Kobe-shi (JP); Naoki YUKAWA, Kobe-shi (JP)

(73) Assignee: Sumitomo Rubber Industries, Ltd., Kobe-shi (JP)

(21) Appl. No.: 17/690,026

(22) Filed: Mar. 9, 2022

(30) Foreign Application Priority Data
Mar. 9, 2021 (JP) 2021-037659

(51) Int. Cl. B60C 19/00; B60C 5/12

(52) U.S. Cl. CPC B60C 19/002; B60C 5/12

(57) ABSTRACT

A pneumatic tire can include a tread portion, a sealant layer on a tire inner cavity surface in the tread portion, a porous sound damper inward of the sealant layer in a tire radial direction, and a barrier portion between the sealant layer and the sound damper. A strength of the barrier portion can be 2 to 25 (N).

### CROSS-REFERENCE TO RELATED APPLICATION

The present application claims priority to Japanese patent application JP 2021-037659, filed on Mar. 9, 2021, the entire contents of which are incorporated herein by reference in its entirety.

### BACKGROUND

### Field

The present disclosure relates to a pneumatic tire.

### Background Art

Japanese Laid-Open Patent Publication No. 2020-104606 suggests a pneumatic tire in which a puncture-preventive sealant layer is disposed on an inner circumferential surface of a tread portion and a sound damper formed of a sponge material is adhered to an inner circumferential surface of the sealant layer. The pneumatic tire may exhibit puncture sealing performance and road noise reducing performance by the sealant layer and the sound damper.

In the above-described pneumatic tire, sealant liquid may permeate the sound damper with the elapse of time, and the sound damper itself may become adhesive. In such a case, if a foreign matter such as a nail penetrates through the tread portion to reach the sound damper, the sound damper may tend to be easily broken. When the foreign matter is pulled out from the tread portion, both bits of the sound damper and the sealant liquid enter the through hole of the tread portion, and degradation of air sealing performance of the sealant liquid may be caused.

### SUMMARY

An aspect involves a pneumatic tire that can include: a tread portion; a sealant layer on a tire inner cavity surface in the tread portion, the sealant layer containing an adhesive sealant liquid; a porous sound damper inward of the sealant layer in a tire radial direction; and a barrier portion between the sealant layer and the sound damper to prevent the sealant liquid from permeating the sound damper, and a strength of the barrier portion can be 2 to 25 (N).

In the pneumatic tire of one or more embodiments of the present disclosure, the barrier portion can be formed by a nonporous surface formed in the sound damper.

In the pneumatic tire of one or more embodiments of the present disclosure, the nonporous surface can be a thermally treated surface.

In the pneumatic tire of one or more embodiments of the present disclosure, the barrier portion can be an adhesive tape.

In the pneumatic tire of one or more embodiments of the present disclosure, the barrier portion can be a resin film.

In the pneumatic tire of one or more embodiments of the present disclosure, the sound damper can be adhered to the barrier portion via an adhesive.

In the pneumatic tire of one or more embodiments of the present disclosure, a specific gravity of the sound damper can be 20 to 80 kg/m³.

In the pneumatic tire of one or more embodiments of the present disclosure, a thickness of the sound damper can be 25 to 40 mm.

In the pneumatic tire of one or more embodiments of the present disclosure, a length of the sound damper in a tire axial direction can be not less than 60% of a length of the sealant layer in the tire axial direction.

In the pneumatic tire of one or more embodiments of the present disclosure, a length of the sound damper in a tire axial direction can be less than 100% of a length of the sealant layer in the tire axial direction.

In the pneumatic tire of one or more embodiments of the present disclosure, a thickness of the barrier portion can be 0.05 to 0.20 mm.

In the pneumatic tire of one or more embodiments of the present disclosure, the barrier portion can cover a side surface, in a tire axial direction, of the sound damper.

In the pneumatic tire of one or more embodiments of the present disclosure, the barrier portion may not cover an inner circumferential surface of the sound damper in the tire radial direction.

In the pneumatic tire of one or more embodiments of the present disclosure, the barrier portion may cover a part of an inner circumferential surface of the sound damper in the tire radial direction.

### BRIEF DESCRIPTION OF THE DRAWINGS

FIG. 1 is a tire meridian cross-sectional view of a pneumatic tire according to one or more embodiments of the present disclosure;

FIG. 2 is an enlarged view of a tread portion shown in FIG. 1;

FIG. 3 is an enlarged cross-sectional view of a sound damper and a barrier portion according to another embodiment of the present disclosure; and

FIG. 4 is an enlarged cross-sectional view of a sound damper and a barrier portion according to another embodiment of the present disclosure.

### DETAILED DESCRIPTION

Embodiments of the present disclosure have been made in view of the above-described circumstances, and an object, from among one or more objects, of one or more embodiments of the present disclosure can be to provide a pneumatic tire that has a sealant layer and a sound damper disposed on a tire inner cavity surface, and can sufficiently exhibit air sealing performance even in a case where a foreign matter penetrates through a tread portion.

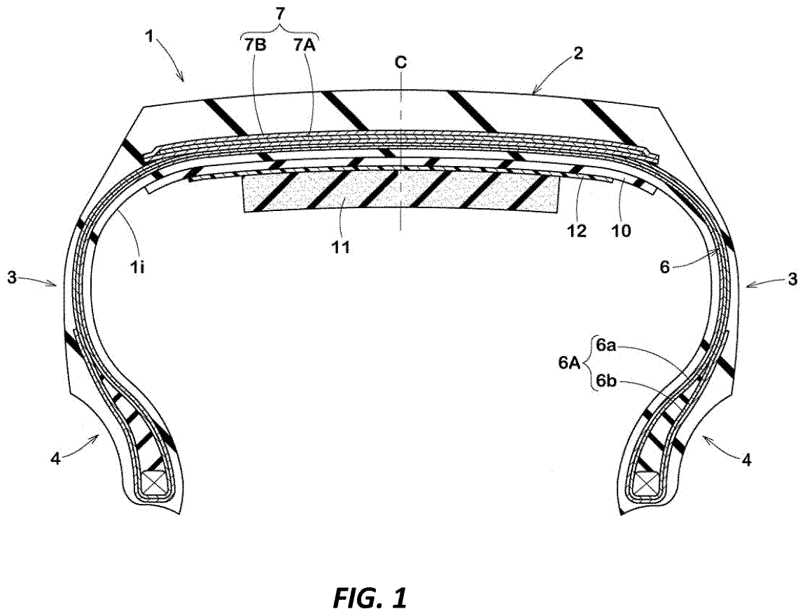

One embodiment of the present disclosure will be described below with reference to the drawings. FIG. 1 is a tire meridian cross-sectional view of a pneumatic tire (hereinafter, may be simply referred to as “tire”) 1 in a normal state according to one or more embodiments of the present disclosure. In the present embodiment, the pneumatic tire 1 for a passenger car will be described. However, embodiments of the present disclosure may be adopted as, for example, a motorcycle pneumatic tire 1 or a heavy duty pneumatic tire 1.

The “normal state” can represent or can be characterized as representing a state where a tire is mounted on a normal rim and inflated to a normal internal pressure, and no load is applied to the tire in a case where the tire is a pneumatic tire for which various standards are defined. For tires for which various standards are not defined, the normal state can represent a standard use state, corresponding to a purpose of use of the tire, in which the tire is not mounted to a vehicle and no load is applied to the tire. In the description herein, unless otherwise specified, dimensions and the like of components of the tire are represented as values measured in the normal state.

The “normal rim” can represent or can be characterized as representing a rim that can be defined by a standard, in a standard system including the standard on which the tire is based, for each tire, and is, for example, “standard rim” in the JATMA standard, “Design Rim” in the TRA standard, or “Measuring Rim” in the ETRTO standard.

The “normal internal pressure” can represent or can be characterized as representing an air pressure that can be defined by a standard, in a standard system including the standard on which the tire is based, for each tire, and is “maximum air pressure” in the JATMA standard, the maximum value recited in the table “TIRE LOAD LIMITS AT VARIOUS COLD INFLATION PRESSURES” in the TRA standard, or “INFLATION PRESSURE” in the ETRTO standard.

As shown in FIG. 1, in the tire 1 of the present embodiment, conventional tire components such as a carcass 6 and a belt layer 7 can be implemented. For the tire components, known structures can be adopted as appropriate.

The carcass 6 can extend from one of bead portions 4 through one of sidewall portions 3, a tread portion 2, and the other of the sidewall portions 3 to the other of the bead portions 4. The carcass 6 can have at least one carcass ply. In the present embodiment, the carcass 6 can have two carcass plies 6A. The carcass ply 6A can be formed by, for example, covering an array of carcass cords with topping rubber. The carcass cord can be, for example, disposed at an angle of 75 to 90° relative to the tire circumferential direction. To the carcass cords, for example, an organic fiber such as polyester fibers, nylon fibers, rayon fibers, polyethylene naphthalate fibers, and aramid fibers can be applied.

The carcass ply 6A can include, for example, a body portion 6a and turned-up portions 6b. The body portion can extend from the tread portion 2 through the sidewall portions 3 to bead cores. Each turned-up portion 6b can be continuous with the body portion 6a, can be turned up around the bead core from the inner side toward the outer side in the tire axial direction, and can extend outwardly in the tire radial direction.

The belt layer 7 can be disposed outward of the carcass 6 in the tire radial direction in the tread portion 2. The belt layer 7 can include at least one belt ply. In the present embodiment, the belt layer 7 can include two belt plies 7A, 7B. The belt plies 7A, 7B can be each formed by, for example, covering an array of belt cords with topping rubber.

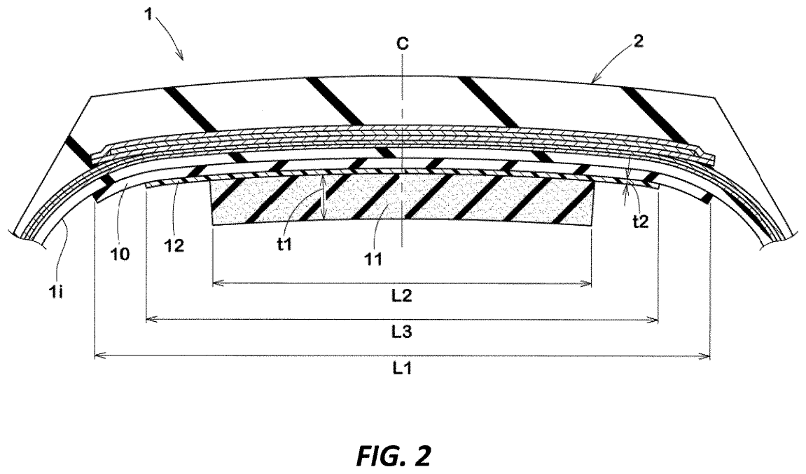

FIG. 2 is an enlarged view of the tread portion 2. As shown in FIG. 2, the tire 1 can have a self-recovering-type sealant layer 10 on a tire inner cavity surface 1i in the tread portion 2. The sealant layer 10 may contain an adhesive sealant liquid. In a case where, for example, a foreign matter such as a nail gets stuck in the tread portion 2 to generate a through hole, the sealant layer 10 can solidity so as to close the through hole, which can prevent air from escaping from the tire 1.

According to one or more embodiments, the tire 1 can have a porous sound damper 11 disposed inward of the sealant layer 10 in the tire radial direction. The sound damper 11 can absorb vibration of air inside the tire 1 during running, and can contribute to reduction of noise generated by the tire 1.

According to one or more embodiments, the tire 1 can include a barrier portion 12 that can be disposed between the sealant layer 10 and the sound damper 11 and can prevent the sealant liquid from permeating the sound damper 11. A strength of the barrier portion 12 can be 2 to 25 (N).

The strength of the barrier portion 12 can represent a strength measured by a puncture strength test defined in JIS1707. That is, the strength can represent a maximal force (N) measured until a needle penetrates through a test piece in a case where the test piece is fixed by a tool, and punctured by the semi-circular needle having a diameter of 1.0 mm and a tip shape radius of 0.5 mm at a test speed of 50±5 mm/min.

According to one or more embodiments of the present disclosure, the tire 1 can have the above-described structure. Therefore, even in a case where a foreign matter penetrates through the tread portion 2, air sealing performance can be sufficiently exhibited. The following mechanism can be inferred as the reason.

In general, a tire having a sealant layer and a sound damper disposed on a tire inner cavity surface may reduce noise during normal running, and can exhibit air sealing performance in a case where a foreign matter gets stuck in the tread portion 2. However, in a conventional tire, the sealant liquid may permeate the sound damper and the sound damper is likely to be partially broken. Furthermore, if the sound damper is broken, when a through hole is generated in the tread portion, bits of the sound damper can enter the through hole, which may degrade air sealing performance.

The tire 1 according to one or more embodiments of the present disclosure can include the barrier portion 12 described above, and thus can effectively prevent the sealant liquid from permeating the sound damper 11, and the above-described problem can thus be inhibited. Moreover, the strength of the barrier portion 12 can be defined as being not less than 2 N. Therefore, the barrier portion 12 can have sufficient durability and can allow air sealing performance to be maintained over a long time. Meanwhile, the strength of the barrier portion 12 can be defined as being not higher than 25 N, and the barrier portion 12 can thus have appropriate flexibility. Therefore, even if the tire inner cavity surface 1i is deformed, the barrier portion 12 may easily follow the sound damper 11, separation of the barrier portion 12 can be inhibited, and the sealant liquid can be assuredly inhibited from permeating the sound damper 11. Moreover, the barrier portion 12 having the flexibility can have excellent processability in producing the tire and can also contribute to decrease of a defect rate in the production.

The structure of the present embodiment will be described below in more detail. The structures described below represent specific modes of the present embodiment. Therefore, needless to say, also when the structures described below are not provided, the embodiments of present disclosure can exhibit the above-described effects. Also when any one of the structures described below is applied alone to the tire of one or more embodiments the present disclosure having the above-described features, improvement of performance corresponding to each structure can be expected. Furthermore, in a case where some of the structures described below are applied in combination, complex performance improvement corresponding to the structures can be expected. The dimensions of the components described below represent dimensions measured when the tire 1 is not mounted on a rim, a distance between the two bead cores is conformed to a distance in the normal state, and no load is applied to the tire.

Although the sealant layer 10 can be disposed on, for example, an inner cavity surface of the tread portion 2, a part of the sealant layer 10 may be disposed on an inner cavity surface of the sidewall portion 3 (shown in FIG. 1). Thus, air sealing performance can be further enhanced.

A thickness of the sealant layer 10 can be, but is not limited to, for example, 1.0 to 5.0 mm and preferably 2.0 to 4.0 mm.

As a component (e.g., a main component) of a rubber composition of the sealant liquid, for example, butyl-based rubber can be used. As a liquid polymer in the sealant liquid, liquid polybutene, liquid polyisobutene, or the like can be used. As a curing agent in the sealant liquid, for example, an organic peroxide can be used. However, embodiments of the present disclosure are not limited thereto. For the sealant liquid contained in the sealant layer 10, a predetermined material can be adopted as appropriate.

The sound damper 11 can be disposed at, for example, the center portion of the tread portion 2 in the tire axial direction. In the present embodiment, the sound damper 11 can have a rectangular cross-sectional shape, and can extend over the entire circumference of the tire so as to have a constant cross-sectional shape. However, the sound damper 11 may not be limited thereto. In one or more embodiments of the present disclosure, for example, a plurality of the sound dampers 11 may be disposed on the tire inner cavity surface 1i, for instance, so as to be spaced from each other in the tire circumferential direction or the tire axial direction. Various structures can be adopted also for the cross-sectional shape of the sound damper 11.

A length L2 of the sound damper 11 in the tire axial direction can be, for example, 60 to 100 mm and preferably 70 to 90 mm. In one particular mode, the length L2 of the sound damper 11 can be less than 100% of a length L1 of the sealant layer 10 in the tire axial direction. Meanwhile, the length L2 of the sound damper 11 can be not less than 60% of the length L1 of the sealant layer 10. Thus, noise performance and air sealing performance can be enhanced in a well-balanced manner.

In a case where a thickness t1 of the sound damper 11 is relatively small, the sound damper 11 may tend to be easily broken and air sealing performance may be degraded. In a case where the thickness of the sound damper 11 is excessively large, enhancement of noise performance may be saturated and the weight of the tire may be increased. From such a viewpoint, the thickness t1 of the sound damper 11 can be, for example, 25 to 50 mm and preferably 30 to 40 mm.

In a case where a specific gravity of the sound damper 11 is excessively small, durability of the sound damper 11 may be reduced. In a case where the specific gravity of the sound damper 11 is excessively large, the weight of the tire may be increased. From such a viewpoint, the specific gravity of the sound damper 11 can be, but is not limited to, for example, 20 to 80 kg/m³ and preferably 30 to 50 kg/m³.

The barrier portion 12 can be structured in various manners. In the present embodiment, the barrier portion 12 can be formed as, for example, a resin film. Examples of a material of the resin film include polyethylene, polypropylene, PET, and polystyrene. Nonwoven fabric may be adopted as another material of the barrier portion 12.

In the present embodiment, the sound damper 11 can be adhered via an adhesive to the barrier portion 12 formed as the resin film. As the adhesive, a rubber-based adhesive, a urethane resin-based adhesive, or a modified silicone resin-based adhesive can be used. In another mode, the sound damper 11 may be adhered to the barrier portion 12 by a rubber-based tackifier, an acrylic tackifier, or a silicone-based tackifier.

In another embodiment, an adhesive tape may be used as the barrier portion 12. That is, the sound damper 11 may be adhered to the sealant layer 10 via the adhesive tape. In such a mode, a core material (resin film or nonwoven fabric) of the adhesive tape can inhibit the above-described permeation, and a similar effect can be obtained.

The barrier portion 12 may be formed by a nonporous surface formed in the sound damper 11. In this mode, the sound damper 11 can be used as a material of the barrier portion 12. Therefore, production cost for the tire can be reduced. Examples of a method for forming the nonporous surface of the sound damper 11 include heating treatments and chemical treatments. That is, the surface of the sound damper 11 may be made nonporous by forming the surface as a thermally treated surface or a chemically treated surface.

From the viewpoint of assuredly inhibiting the above-described permeation, a length L3 of the barrier portion 12 in the tire axial direction can be greater than a length of the outer circumferential surface of the sound damper 11 in the tire axial direction. Thus, even in a case where the sound damper 11 may be deformed due to a centrifugal force in rotation of the tire, the sound damper 11 can be prevented from coming into contact with the sealant layer 10. As described below, the barrier portion 12 may be disposed at another portion such as a side surface of the sound damper 11.

The strength of the barrier portion 12 can be not less than 5 N and more preferably not less than 10 N, and can be preferably not higher than 20 N and more preferably not higher than 15 N. A thickness t2 of the barrier portion 12 can be, for example, 0.05 to 0.20 mm and preferably 0.10 to 0.15 mm. Thus, air sealing performance can be further enhanced.

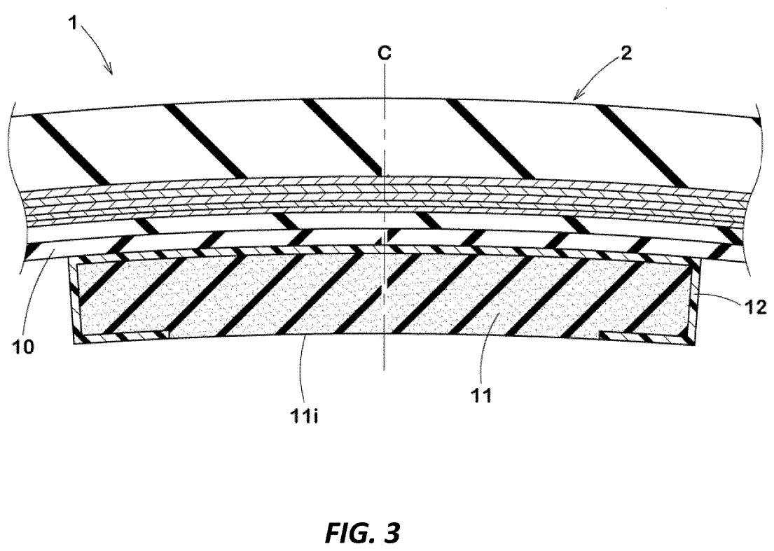

FIG. 3 is an enlarged view of the sound damper 11 and the barrier portion 12 according to another embodiment of the present disclosure. As shown in FIG. 3, the barrier portion 12 of the present embodiment can be disposed so as to cover the entirety of the side surfaces, in the tire axial direction, of the sound damper 11 and a part of an inner circumferential surface 11i of the sound damper 11 in addition to being disposed between the sealant layer 10 and the sound damper 11. The barrier portion 12 having such a structure can reduce damage to the side surfaces of the sound damper 11 and can enhance air sealing performance.

An area of the barrier portion 12 disposed on the inner circumferential surface 11i of the sound damper 11 may not be greater than 50% of an area of the entirety (including the portion covered by the barrier portion 12) of the inner circumferential surface 11i of the sound damper 11 and can be preferably 5% to 25% thereof such that the above-described effect can be exhibited while vibration absorbing performance of the sound damper 11 can be assured.

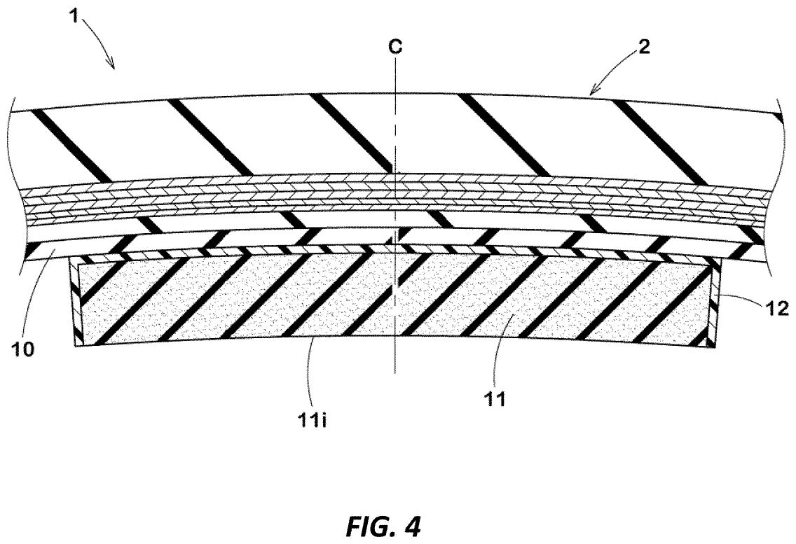

FIG. 4 is an enlarged view of the sound damper 11 and the barrier portion 12 according to still another embodiment of the present disclosure. As shown in FIG. 4, the barrier portion 12 of the present embodiment can be disposed so as to cover the entirety of the side surfaces, in the tire axial direction, of the sound damper 11 in addition to being disposed between the sealant layer 10 and the sound damper 11. Meanwhile, the barrier portion 12 of the present embodiment may not cover the inner circumferential surface 11i of the sound damper 11. In the present embodiment, a vibration absorbing surface of the sound damper 11 can be assuredly increased while damage to the side surfaces of the sound damper 11 can be reduced.

A pneumatic tire having a sealant layer and a sound damper disposed on a tire inner cavity surface, according to one or more embodiments of the disclosed subject matter, can sufficiently exhibit air sealing performance even in a case where a foreign matter penetrates through a tread portion. Although the pneumatic tire according to one embodiment of the present invention has been described above in detail, the present invention is not limited to the above-described specific embodiment, and various modifications can be made to implement the present invention.

### Examples

Pneumatic tires having the basic structure shown in FIG. 1 and a size of 215/55R17 based on the specifications in Tables 1 to 2 were produced. As a comparative example, a sample of a pneumatic tire having no barrier portion was produced. The tire of the comparative example had substantially the same structure as the tires of the examples except for the above-described component. The thickness of the sealant layer was 3.0 mm in each test tire. The length of the sealant layer in the tire axial direction was 186 mm in each test tire. For these test tires, air sealing performance was tested. The specifications common to the test tires and the test method were as follows.

Rim on which the tire was mounted: 17×7.5J

Tire internal pressure: 250 kPa

### Air Sealing Performance

Running with each test tire on a drum tester in a state where a vertical load of 4.6 kN was applied to the tire was performed at a speed of 200 km/h for one hour. Thereafter, 50 nails (diameter of 5.0 mm) were driven into the tread portion. After theses nails were removed, the number of portions (portions at which air leakage stopped) at which an air sealing effect was exhibited by the sealant layer was measured. The results are such that the greater the number is, the more excellent the exhibited air sealing performance is.

The test results are indicated in Tables 1 to 2.

TABLE 1

| | Comp. | | | | | | | | |
|---|---|---|---|---|---|---|---|---|---|
| | Ex. | Ex. 1 | Ex. 2 | Ex. 3 | Ex. 4 | Ex. 5 | Ex. 6 | Ex. 7 | Ex. 8 |
| Presence or | absent | present | present | present | present | present | present | present | present |
| absence of | | | | | | | | | |
| barrier portion | | | | | | | | | |
| Material of | — | resin | resin | resin | resin | resin | resin | resin | resin |
| barrier portion | | film | film | film | film | film | film | film | film |
| Strength (N) of | — | 13 | 2 | 5 | 10 | 15 | 20 | 25 | 13 |
| barrier portion | | | | | | | | | |
| Specific gravity | 40 | 40 | 40 | 40 | 40 | 40 | 40 | 40 | 15 |
| (kg/m³) of sound | | | | | | | | | |
| damper | | | | | | | | | |
| Thickness t1 | 35 | 35 | 35 | 35 | 35 | 35 | 35 | 35 | 35 |
| (mm) of sound | | | | | | | | | |
| damper | | | | | | | | | |
| Air sealing | 35 | 46 | 44 | 45 | 45 | 46 | 48 | 48 | 42 |
| performance | | | | | | | | | |
| (the number of | | | | | | | | | |
| the portions) | | | | | | | | | |

TABLE 2

| | Ex. 9 | Ex. 10 | Ex. 11 | Ex. 12 | Ex. 13 | Ex. 14 | Ex. 15 | Ex. 16 |
|---|---|---|---|---|---|---|---|---|
| Presence or | present | present | present | present | present | present | present | present |
| absence of | | | | | | | | |
| barrier portion | | | | | | | | |
| Material of | resin | resin | resin | resin | resin | Thermally | nonwoven | adhesive |
| barrier portion | film | film | film | film | film | treated | fabric | tape |
| | | | | | | surface of | | |
| | | | | | | sound | | |
| | | | | | | damper | | |
| Strength (N) of | 13 | 13 | 13 | 13 | 13 | 3 | 5 | 6 |
| barrier portion | | | | | | | | |
| Specific gravity | 20 | 80 | 40 | 40 | 40 | 40 | 40 | 40 |
| (kg/m³) of sound | | | | | | | | |
| damper | | | | | | | | |
| Thickness t1 (mm) | 35 | 35 | 20 | 25 | 40 | 35 | 35 | 35 |
| of sound damper | | | | | | | | |
| Air sealing | 45 | 47 | 41 | 45 | 49 | 47 | 45 | 46 |
| performance | | | | | | | | |
| (the number of | | | | | | | | |
| the portions) | | | | | | | | |

As indicated in Tables 1 to 2, it was confirmed that the tires of the examples sufficiently exhibited air sealing performance even in a case where a foreign matter penetrated through the tread portion.

What is claimed is:

1. A pneumatic tire comprising:
a tread portion;
a sealant layer on a tire inner cavity surface in the tread portion, the sealant layer containing an adhesive sealant liquid;
a porous sound damper inward of the sealant layer in a tire radial direction; and
a barrier portion between the sealant layer and the sound damper to prevent the sealant liquid from permeating the sound damper, wherein
a strength of the barrier portion is 2 to 25 (N).

2. The pneumatic tire according to claim 1, wherein the barrier portion is formed by a nonporous surface formed in the sound damper.

3. The pneumatic tire according to claim 2, wherein the nonporous surface is a thermally treated surface.

4. The pneumatic tire according to claim 1, wherein the barrier portion is an adhesive tape.

5. The pneumatic tire according to claim 1, wherein the barrier portion is a resin film.

6. The pneumatic tire according to claim 5, wherein the sound damper is adhered to the barrier portion via an adhesive.

7. The pneumatic tire according to claim 1, wherein a specific gravity of the sound damper is 20 to 80 kg/m³.

8. The pneumatic tire according to claim 1, wherein a thickness of the sound damper is 25 to 40 mm.

9. The pneumatic tire according to claim 1, wherein a length of the sound damper in a tire axial direction is not less than 60% of a length of the sealant layer in the tire axial direction.

10. The pneumatic tire according to claim 1, wherein a length of the sound damper in a tire axial direction is less than 100% of a length of the sealant layer in the tire axial direction.

11. The pneumatic tire according to claim 1, wherein a thickness of the barrier portion is 0.05 to 0.20 mm.

12. The pneumatic tire according to claim 1, wherein the barrier portion covers a side surface, in a tire axial direction, of the sound damper.

13. The pneumatic tire according to claim 12, wherein the barrier portion does not cover an inner circumferential surface of the sound damper in the tire radial direction.

14. The pneumatic tire according to claim 12, wherein the barrier portion covers a part of an inner circumferential surface of the sound damper in the tire radial direction.
